(19) United States
(12) Patent Application Publication
(10) Pub. No.: US 2010/0302284 A1
(43) Pub. Date: Dec. 2, 2010

(54) ELECTRO-OPTICAL DEVICE

(75) Inventor: Nobuo KARAKI, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/725,801

(22) Filed: Mar. 17, 2010

(30) Foreign Application Priority Data
Jun. 2, 2009 (JP) 2009-133541

(51) Int. Cl. G09G 5/10; G06F 3/038

(52) U.S. Cl. 345/690; 345/204; 345/1.3

(57) ABSTRACT

An electro-optical device that facilitates assembly of the electro-optical device composed of a plurality of display tiles on a wall surface, and its assembly method are provided. It includes a plurality of display tiles, and a foundation structure having a plurality of regions, wherein the foundation structure is equipped with a signal bus for transmitting an image data signal to a first display tile among the plurality of display tiles, and a first connection section that electrically connects the signal bus with the first display tile, and the first display tile is equipped with pixel elements, a signal processing section that generates signals for driving the pixel elements based on the image data signal, and a second connection section that is electrically connected to the first connection section.

The present application claims priority based on Japanese Patent Application 2009-133541 filed Jun. 2, 2009, and the application is herein incorporated in this specification.

### TECHNICAL FIELD

The present invention relates to electro optical devices and the like, and for example, relates to electro optical devices, display tiles and the like which may be installed along so-called moving sideways and the like in stations, airports and the like, which are suitable for large screen displays that may be installed in theaters and stadiums.

### TECHNOLOGICAL BACKGROUND

In a direct-view type display device with a large-size screen, such as, for example, a display device that is laterally arranged along a passage on the wall surface of the passage, the number of pixels on the screen is considerably large, such that the number of image data to be handled is enormous, and therefore the display device requires an extremely high data processing capability. For example, input of picture signals is performed by a pixel progressive system or the like based on a dot-sequential system or a line progressive display system using a serial-parallel converter for each one row (1 RAW); and according to these systems, the clock frequency of input signals substantially increases as the display screen becomes larger in size, in other words, as the amount of frame data increases.

For example, when the frame size is 4 k×2 k and the frame frequency is 24 FPS (Frame Per Second), the rate fclk (PPS, Pixel Per Second) at which pixel data is inputted is fclk>24×4×10³×2×10³=192 (MPPS). In the case of a 24 bit color display, each of RGB colors has one byte, such that, for example, even when data is inputted in 8 bit-serial, in other words, 8 bits simultaneously, it is necessary to input the display data at an extremely high rate of 576 MBPS (Bytes Per Second). When the input is done in bit-serial, the bit rate of 4.61 GPBS is necessary.

In this respect, the present applicant proposed an electro-optical device and the like described in Japanese Laid-open Patent Application 2006-047901. In this technology, a display screen is formed by installing a plurality of direct-view type display tiles each being capable of high definition display and composed of a multilayer structure in which a display device and its control circuit are formed in at least 2 layers, wherein images are updated by a so-called frame sequential method. A margin of the data processing time is reduced to the afterimage effect of visual perception (for example, a frame period of 1/60 sec.) whereby the processing with a low-speed CPU is made possible. Also, a display with an ultra large-size screen is made possible by laying and installing a plurality of direct-view type display tiles each having a multilayer structure capable of high resolution display.

### PRIOR ART DOCUMENT

### Patent Document

[PATENT DOCUMENT 1] Japanese Laid-open Patent Application HEI 2006-47901 (Paragraph 0116, FIG. 12, etc.)

### SUMMARY OF THE INVENTION

### Problems to be Solved by the Invention

When installing the direct-view type display tiles having the multilayer structure described above on a wall surface or the like, the display tiles must be correctly arranged on the wall surface, and the display tiles must correctly display each screen as a whole.

However, it is not easy to correctly arrange and assemble display tiles to form a large screen on a surface, such as, a wall surface, a ceiling or the like of a building, such as, so-called moving sideways, a theater, a movie theater, an arena and the like.

Accordingly, in accordance with an embodiment of the invention, an electro-optical device that facilitates assembly of the electro-optical device composed of a plurality of display tiles on a wall surface, and its assembly method are provided.

### Means to Solve the Problems

An embodiment of the invention includes a plurality of display tiles and a foundation structure having a plurality of regions, wherein the foundation structure is equipped with a signal bus for transmitting an image data signal to a first display tile among the plurality of display tiles, and a first connection section that electrically connects the signal bus with the first display tile, and the first display tile is equipped with pixel elements, a signal processing section that generates signals for driving the pixel elements based on the image data signal, and a second connection section that is electrically connected to the first connection section.

With such a structure provided, it is possible to form an electro-optical device with a large-size screen along a wall surface.

Here, the “electro-optical device” is capable of displaying images, information and the like using functional elements that convert electrical signals to light signals, and refers to a concept including a liquid crystal display device (LCD), an organic EL display device (high polymer, low polymer), an electrophoretic display device, a light emitting diode (LED) array display device, a plasma display and the like. Also, an “installation object” includes a large surface (including a curved surface), such as, a wall surface, a floor surface, a ceiling or the like of a structure on a building that is a real estate. Also, it includes an installation surface for a screen, a display board, an advertisement board or the like at moving sideways, a variety of theaters (including movie theaters), a variety of arenas, restaurants and the like. Also, it may be a wall surface (a flat surface section) of a movable property, such as, a large-sized vehicle, an airplane, a ship or the like. It may have more or less a curved surface (curve).

Also, it is preferred that the first connection section may also serve as the first mounting section, and the second connection section may also serve as the second mounting section. As the connection sections have a function to install the display tiles on the foundation structure, the structure of the device is simplified.

Also, in accordance with an embodiment of the invention, an electro-optical device that forms a large-size screen by combining a plurality of display tiles each of which displays a small-size screen, wherein each of the display tiles is equipped with a signal bus for transmitting an image data signal, a connection section that electrically connects the signal buses with one another on adjoining ones of the display tiles, a plurality of pixel elements that form the small-size screen, and a signal processing section that forms a signal for driving each of the pixel elements from the image data signal.

According to such a structure, it is possible to form an electro-optical device with a large-size screen along a wall surface or the like.

The large-size screen may be formed by two-dimensionally arranging the plurality of display tiles and connecting the connection sections of adjoining ones of the display tiles with one another, and it is preferred to further include an interface section that is provided at least at one end section of the large-size screen composed of the plurality of display tiles and relays an externally supplied image data signal to the signal bus of each of the plurality of display tiles disposed at the one end section. Accordingly, by externally supplying image signals to the interface section, the same can be transmitted to each of the display tiles.

It is preferred that the plurality of display tiles may include those in different configurations and different numbers of pixel elements. This makes it possible to form display sections that can accommodate various states in shape and strength of wall surfaces and various circumstances relating to manufacturing or the like, and to be used in various applications.

It is preferred that the signal processing section of the display tile may perform signal processing according to a hierarchical structure, and may include an uppermost layer that serves as an input interface for the image data, a lowermost layer in which the plurality of pixel elements and a plurality of pixel element driving circuits each corresponding to each of the pixel elements are arranged, and a middle layer that processes and computes data supplied from an upper layer and supplies the same to a lower layer. By this, pixel data that is defined (allocated) by a logic space of the display tile from the original image data, and a group of pixel signals for the respective pixel elements of the display tile can be formed from the pixel data. By this, images of each of the display tiles can be updated simultaneously.

It is preferred that the display tile may further include a non-volatile memory device that stores errors from a target color and/or a target luminance caused by variations in each of the pixel elements and changes with time, and may be equipped with a device that calculates an input value for the pixel element in the lowermost layer in a manner to cancel the errors stored in the non-volatile memory. By this, variations in characteristics of the pixel elements can be corrected, whereby a large-size screen display device with high image quality and high definition can be provided.

### BRIEF DESCRIPTION OF THE DRAWINGS

FIG. 1 is an explanatory view for explaining an electro-optical device with a large-size screen in accordance with the invention.

FIG. 2 is an explanatory view for explaining an electro-optical device in accordance with a first embodiment.

FIG. 3 is an explanatory view for explaining a structure example of a foundation structure.

FIG. 4 show explanatory views for explaining an example of a display tile in accordance with the first embodiment.

FIG. 5 is an explanatory view for explaining a signal processing section having a multilayer structure disposed in the display tile.

FIG. 6 is an explanatory view for explaining an example of an element processor composing one layer.

FIG. 7 is an explanatory view for explaining examples of plural kinds of display tiles.

FIG. 8 is an explanatory view for explaining an example of an electro-optical device in accordance with a second embodiment.

FIG. 9 is an explanatory view for explaining an example of display tiles in accordance with the second embodiment.

FIG. 10 is a flow chart for explaining an example of assembly of a display tile (a method of manufacturing an electro-optical device with a large-size screen on site).

FIG. 11 shows explanatory views for explaining a process of assembling display tiles.

FIG. 12 is an explanatory view for explaining correction of a display body.

FIG. 13 is an explanatory view for explaining an example of an electro-optical device in accordance with a third embodiment.

FIG. 14 is an explanatory view for explaining an example of display tiles in accordance with the third embodiment.

### EMBODIMENTS OF THE INVENTION

Hereinbelow, embodiments of the invention will be described with reference to the drawings.

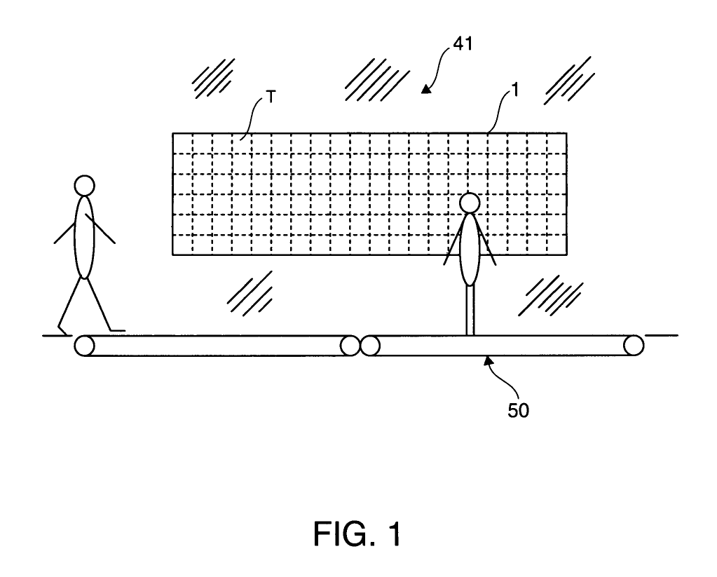

FIG. 1 shows an example of an electro-optical device in accordance with the invention, and moving sideways 50 are installed along a passage in a train station, an airport or the like. As the moving sideways 50, a known belt conveyor system or escalator system may be used. An electro-optical device with a large-size screen 1 is installed on a wall surface 41 along the moving sideways 50. As described in detail later, the electro-optical device 1 is laterally formed in an extending direction of the passage by installing display tiles T each displaying an image of a predetermined region, arranged in a matrix configuration (a two-dimensional arrangement) on the wall surface. Each display tile is provided with a display surface (an element array for pixel display), a data processing device, an interface and the like. The electro-optical device 1 is disposed at a position that can be readily viewed by pedestrians on the moving sideways. For example, screen images displayed on the screen of the electro-optical device 1 can be shifted in synchronism with the amount of movement (or the moving speed) of the moving sideways.

The screen of the electro-optical device 1 may have any size, and is not limited to the one illustrated. For example, it can be installed over the entire wall or on a part thereof of a structure, a ceiling or the like. Also, without being limited to the moving sideways, it may be installed as a projection screen, a wall surface, a ceiling, a floor surface, a fence or the like at a theater, a movie theater, an arena or the like.

### First Embodiment

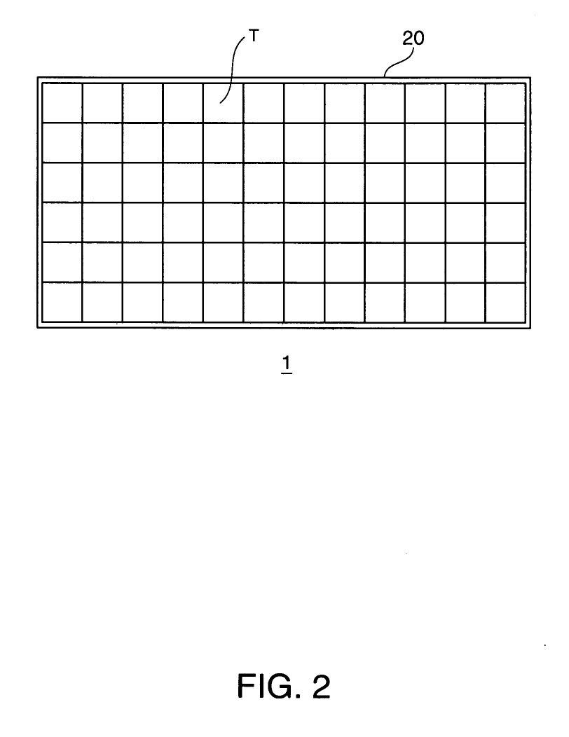

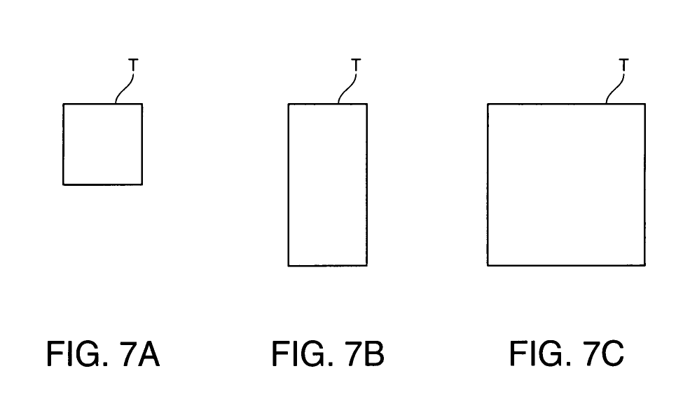

FIG. 2 through FIG. 7 show the electro-optical device with a large-size screen 1 in accordance with the first embodiment. As shown in FIG. 2, the electro-optical device with a large-size screen 1 is formed by combining a plurality of display tiles T each displaying a predetermined region. In this example, the display tiles T are two-dimensionally arranged on a foundation structure 20 in a row (lateral) direction and a column (longitudinal) direction. As described below (FIG. 7), display tiles T in different shapes can be combined. The foundation structure 20 may be fixed to the wall surface by means of embedding, retaining with bolts, lamination or the like. The foundation structure 20 may be manufactured, for example, in a factory. Data for a building structure at an installation location may be input in a computer system to design the foundation structure 20. It is noted that the foundation structure 20 is illustrated as being somewhat larger than a display region (a collection of Ts), for the convenience of description, but both of them may have the same area (in a so-called frame-less state).

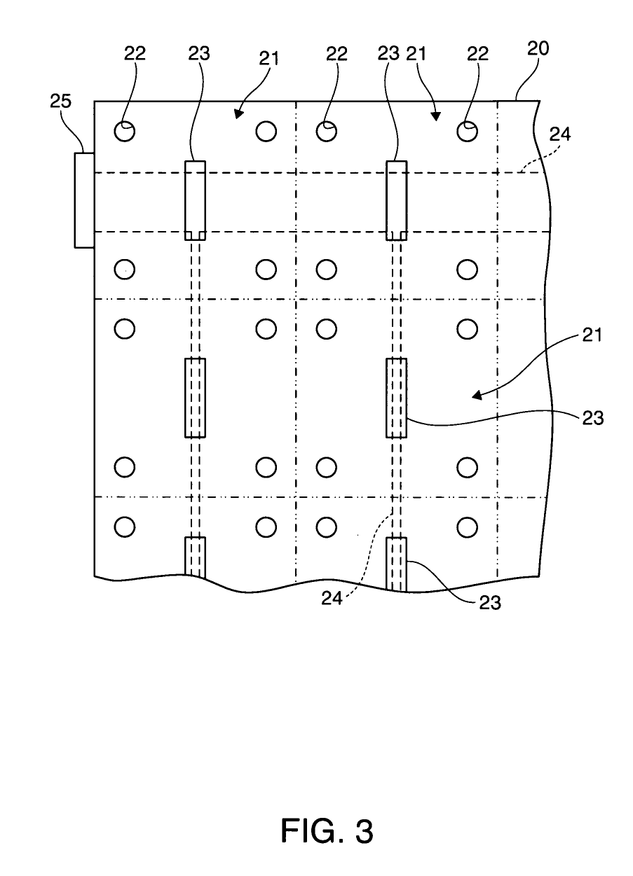

FIG. 3 shows a portion of the structure example of the foundation structure 20. As shown in the figure, the foundation structure 20 is divided into a plurality of regions (segments indicated by two-dot-and-dash lines in the FIG. 21 corresponding to the shapes of the display tiles T, and each of the regions 21 is provided with one or a plurality of first mounting sections 22 for installing display tiles, and one first connection section (connector) 23. It is noted that the number of the first connection section 23 is limited to one. Further, the foundation structure 20 is formed in a box shape or a plate shape in a small thickness from a thin steel plate or a resin plate, and is provided on the inside or the rear surface side with a signal bus 24 indicated in the figure by dotted lines for supplying image data signals and power supply. The signal bus 24 connects an external connection section 25 provided at an end section of the foundation structure 20 with the connection section 23 of each of the regions 21, thereby transmitting image data to each of the display tiles T. Also, the signal bus 24 mutually connects the display tiles T, thereby enabling error corrections or the like through an internal process of the display tiles T.

The first mounting section 22 described above may be, for example, mounting holes, and four of them may be provided in each one region 21, without any particular limitation to this. The mounting section 22 may be screw holes or have an engagement (latch) structure, hook-and-loop fasteners or the like. Preferably, the first mounting section 22 is structured in a manner to allow fine adjustment of the position of the display panel. Also, the first mounting section 22 may be adhesive, whereby the display tiles T may be adhered to the foundation structure. The connection section 23 is a connector that electrically connects the signal bus 24 with the display tiles T; and the connection section 23, if equipped with a required mechanical strength, can fix the display tiles T, and makes the first mounting section 22 and the second mounting section 51 unnecessary.

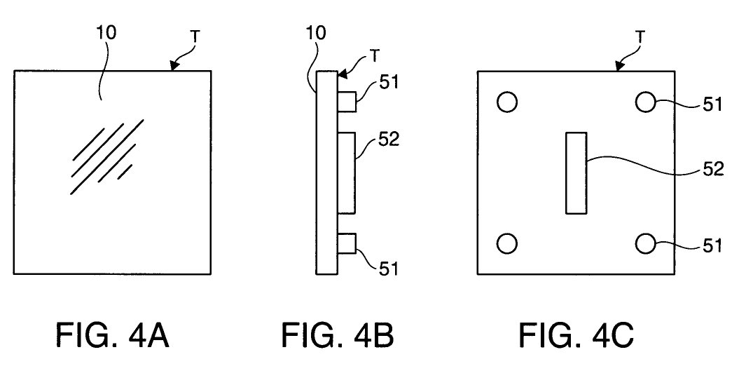

FIG. 4 schematically show the external appearance of the display tile, wherein (A) of the figure is a front view, (B) of the figure is a side view, and (C) of the figure is a rear view.

As shown in the figures, the front surface of the display tile defines a display surface 10, and has pixel elements arranged therein. The rear surface of the display tile is provided with one or a plurality of second mounting sections 51 for installing itself to the foundation structure 20 and at least one second connection section (connector) 52. The second mounting section 51 and the second connection section 52 are provided each in a number required at positions corresponding to the first mounting section 22 and the first connection section 23 provided in each of the regions 21 of the foundation structure 20.

The second mounting section 51 may be, for example, screws and elastic pins, engagement members or the like, without any particular limitation thereto. For example, hook-and-loop fasteners, adhesive or the like may also be used. Preferably, the second mounting section 51 is structured in a manner to allow fine adjustment of the position of the display panel T.

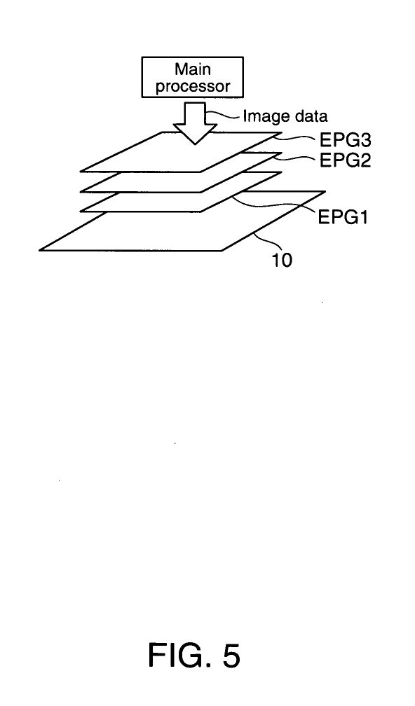

As shown in FIG. 5, the display tile T is equipped internally with functions as a display device for displaying a predetermined region. As the display tile T, for example, a display tile described in Japanese Laid-open Patent Application 2006-47901 may be used. This publication describes a display device with a large-size screen formed through combining display tiles, and is therefore briefly described here.

Image data for each of the regions to be displayed is transmitted from an external main processor that stores data for a large-size screen image through the signal bus 24 to the corresponding one of the display tiles T. The display tile T has a signal processing section structured to perform signal processing in a plurality of hierarchical layers. For example, an element processor composing a signal processing system is divided into three hierarchical layers, which are mutually connected.

More specifically, a first element processor group EPG1, a second element processor group EPG 2 and a third element processor group EPG3 are provided in this order from the lowermost layer. The first element processor group EPG1 at the lowermost layer corresponds to a group of pixel elements arranged in a matrix configuration of n rows×m columns that display a predetermined region.

Data flows from the uppermost layer to the lowermost layer. In other words, image data is input from the main processor to the third element processor group EPG3. Pixel data is supplied from the upper third element processor group EPG3 to each of second element processors EP2 in the second element processor group EPG2. Each of the second element processors EP2 forming the second element processor group EPG2 supplies pixel data to each of regions in a specified number in the first element processor group EPG1.

At boundaries between the regions in the first element processor group EPG1, communication channels are provided between them so that error data for the mutual element processors is supplied beyond the boundaries to disperse the error without forming discontinuity.

In the embodiment, the third element processor group EPG3 decodes encoded original image data U so as to output the decoded image data V. Other than decoding, a process for generating raster data from vector data can be performed. The second element processor group EPG2 executes a calculation process of the decoded image data V. That is, predetermined processes in logical pixel space, such as, three-dimensional processes including rotating, scaling, page-turning, etc., and color conversion processes including color reversing, etc., are performed. Then, each pixel data X that has a fixed position (address) in physical pixel space as a raster image is output. The first element processor group EPG1 renders quantization (error diffusion) on each pixel data X, and outputs pixel data Y having been error-diffused and has a reduced grayscale.

A pixel driver GD drives the display element GE with current (power) of an amount corresponding to the pixel data Y so as to display a pixel in accordance with a density of the pixel data Y. Element processors (group) of each layer should include a configuration enough to perform the image processing assigned to each layer. For example, the third element processor EP3 is capable of supplying image data V of pixel base to the second element processor EP2, and is equipped with co-processors, frame memories, memories such as RAM, etc., FIFO memories for adjusting a time axis, etc. that are enough to decode compressed image data U. The second element processor EP2 is equipped with co-processors, DSP, frame memories, memories such as RAM, FIFO memories, etc., for executing a coordinate conversion process.

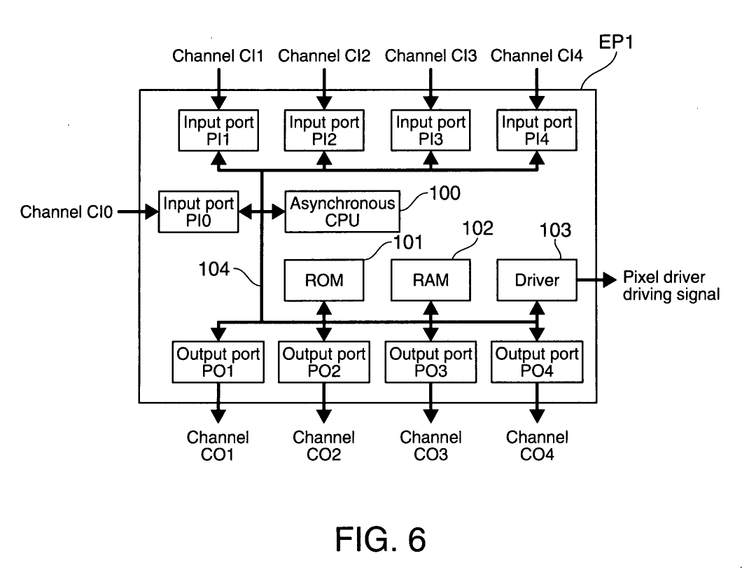

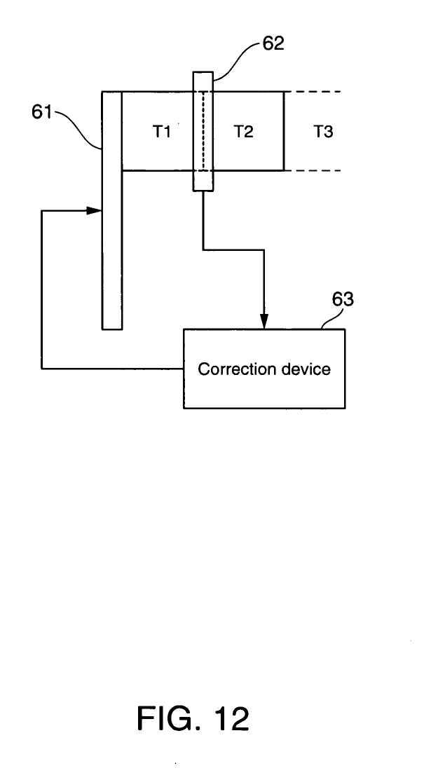

FIG. 6 illustrates a structure example of the first element processor EP1, as an example of the element processor. As shown in the figure, the first element processor EP1 is configured with an asynchronous CPU 100, a ROM 101, a RAM 102, a driver interface circuit 103, an input port PI0, input ports PI1 through PI4, and output ports PO1 through PO4 being interconnected with an internal bus 104. Pixel data enter the input port PI0 from the upper hierarchical layer. Quantization error data enter the input ports PI1 through PI4 from adjoining ones of the first element processors in the same hierarchical layer. The output ports PO1 through PO4 output quantization error data to adjoining ones of the first element processors in the same hierarchical layer. The ROM 101 can store data for correcting pixels that are generated based on data that is output from a correction device to be described below (FIG. 12) and input in the uppermost layer through the foundation structure.

It is desirous that the signal processing section thus composed includes a non-volatile memory device that stores errors from target color and target luminance and the like caused by variations among the pixel elements and changes with time, and the ROM 101 may store such data. It is also desired that the CPU 100 calculates input values of the pixel elements at the lowermost layer in a manner to cancel out the errors stored in the ROM 101. Accordingly, variations in the characteristics of pixel elements can be corrected, and a large device with high image-quality and high-definition can be provided.

In this manner, as image data for one screen is supplied from the main processor to the electro-optical display device 1, the image data is assigned to each of the regions of each of the display tiles composing the screen, thereby performing a display on the large screen.

FIG. 7 show variations in the display tiles T. (A) of the figure shows a display tile T in a square shape. (B) of the figure shows an example of a display tile in a rectangular shape with an area two times greater than the base display tile by extending it in the up-down direction in the figure. (C) of the figure shows an example of a display tile in a square shape with an area four times greater than the base display tile by extending it in the up-down direction and in the left-right direction in the figure. If the area is an integer multiple of the base display tile, they can be attached to the foundation structure 20.

By using such display tiles, regions different in the display characteristics can be provided in a large screen. For example, even by using display tiles that have relatively low responsiveness and image quality in regions in the large screen where movements are fewer or less visible to lower the cost, it is possible to avoid deterioration of the impression of the overall image quality given to observers. Also, display tiles in specific shapes and characteristics corresponding to the states (spaces, curves and the like) of wall surfaces of installation locations can be used.

It is noted that the display tile T may be a flexible sheet-like structure using a pixel element array composed of liquid crystal elements, organic EL elements, electrophoretic elements or the like formed on a film. Even when a wall surface has a curve, an electro-optical display device with a large-size screen can be formed along the curve by using the foundation structure 20 in a film shape. In this case, the display tiles T and the foundation structure 20 can be bonded together with adhesive. Electrical connection between the display tiles T and the foundation structure 20 may be done through an anisotropic conductive film.

### Second Embodiment

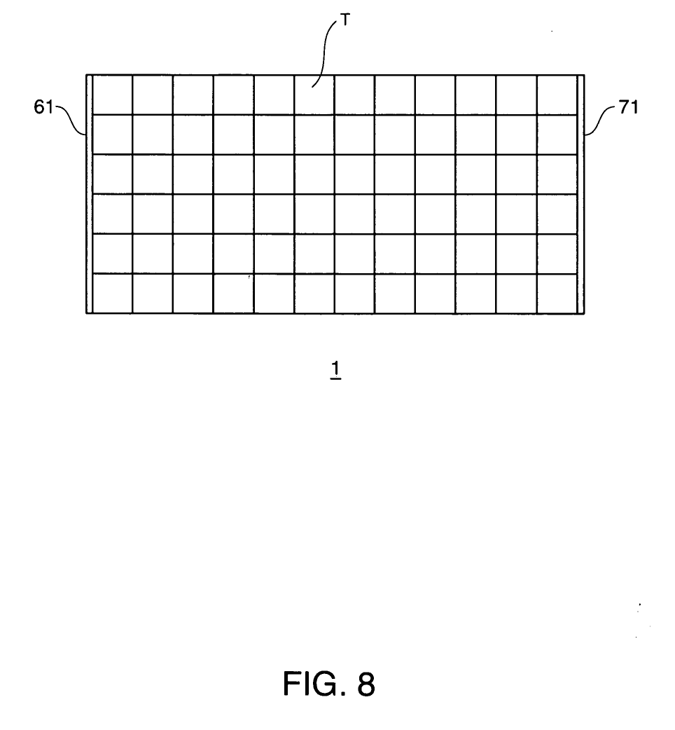

FIG. 8 through FIG. 11 are explanatory views for describing a second embodiment of the invention.

According to the second embodiment, display tiles are installed on a wall surface without using the foundation structure 20. For this, a signal bus is built in each of the display tiles, and structured such that the signal buses of the display tiles can be mutually connected.

As shown in FIG. 8, in accordance with the second embodiment, the display tiles T are arranged in rows and columns, and the display tiles T are mutually connected, thereby forming an electro-optical display device with a large-size screen 1. An interface section 61 is provided at one end (on the side of a short side) of the laterally oblong screen, for transmitting externally supplied image data signals to the array of display tiles. The signal buses of the tiles are connected together within the display tile array, whereby a single signal bus is formed. An end terminal device 71 is provided at the other end (on the side of another short side) of the laterally oblong screen to prevent signal reflection at the end terminal of the signal bus. Each of the display tiles T may be fixed to a wall surface by, for example, bonding their back surfaces directly to the wall surface with adhesive.

Although not particularly illustrated, a display surface 10 is formed on the front surface of each of the display tiles T, and a signal processing section is built therein, like that shown in FIG. 4 (A). Further, connection sections 52, which are provided at the rear surface in the first embodiment, are provided at the side surface of the display tile T in the second embodiment.

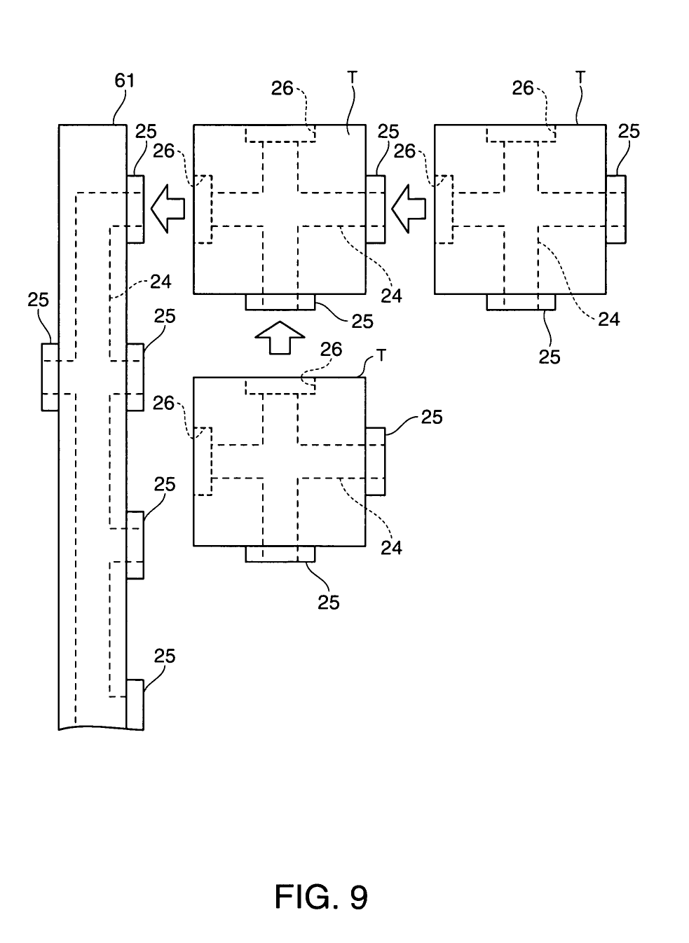

FIG. 9 shows the display tiles T and an interface section 61. As shown in the figure, a female connection section 26 is provided on the left side surface of the display tile T, a male connection section 25 is provided on the right side surface thereof, and the signal bus 24 in the lateral direction is formed between the female connection section 26 and the male connection section 25. Also, a female connection section 26 is provided on the upper side surface of the display tile T, a male connection section 25 is provided on the lower side surface thereof, and the signal bus 24 in the longitudinal direction is formed between the female connection section 26 and the male connection section 25.

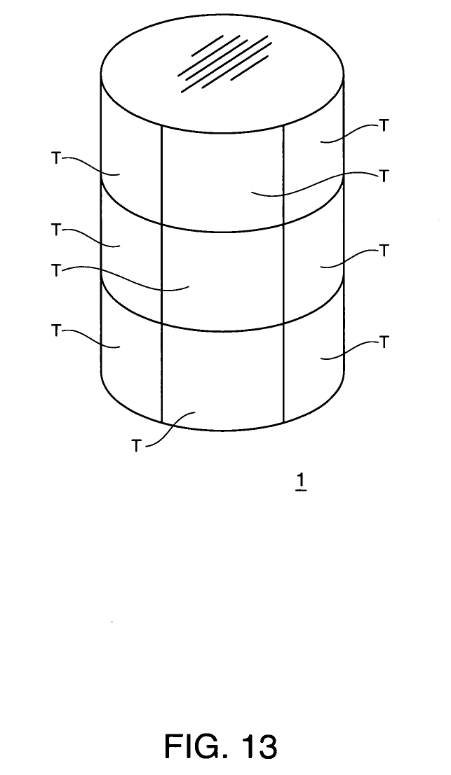

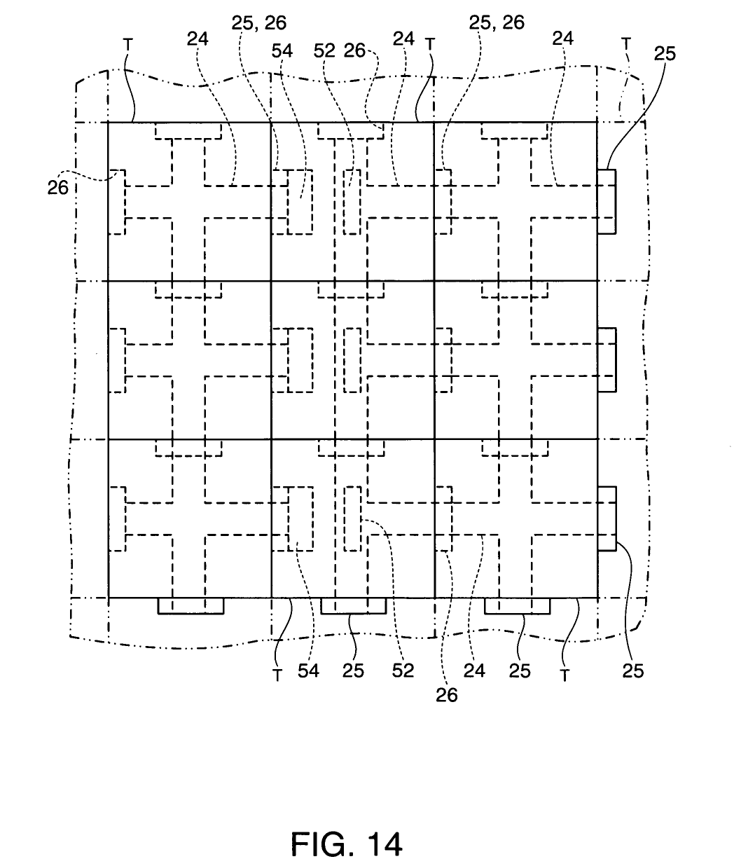

It is noted that, as described below (FIG. 13 and FIG. 14), an interface section 61 and an end terminal device 71 may be built in the display tile T.

The male connection sections 25 of the display tiles T can be coupled to the female connection sections 26 of the display tiles T, whereby the display tiles T are mutually coupled at the connection sections. In the display tile array coupled in this manner, the female connection sections 26 are connected to the male connection sections 25 of the interface section 61, respectively. The display tile array and the interface section 61 are coupled by the female and male connection sections 25 and 26. The male connection sections 25 are mutually connected by the signal bus 24 inside the interface section 61. As an image data signal is supplied from outside to the connection section 25 of the interface section 61, the same is transmitted to each of the display tiles T.

By combining the display tiles in this manner, an electro-optical display device with a large-size screen can be formed.

### (Assembly and Mounting)

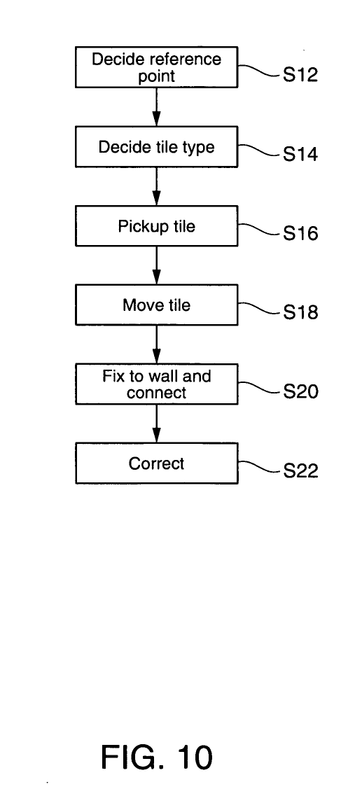

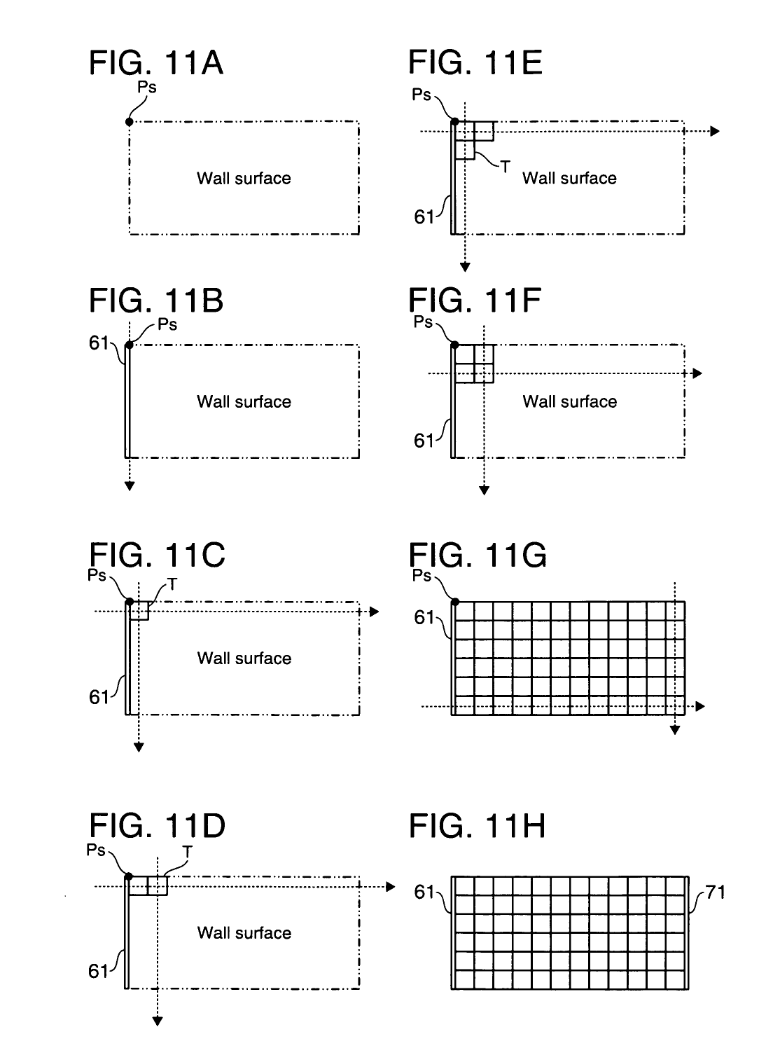

Assembly of the display tiles is described with reference to a flow chart in FIG. 10 and an explanatory view in FIG. 11, using installation thereof to a wall surface as an example.

First, as shown in FIG. 11 (A), a reference point Px is set on a wall surface (step S12). As shown in FIG. 11 (B), a laser marker (laser beam) passing through the reference point Ps is irradiated on the wall surface by a laser measurement device not shown, thereby setting a vertical reference line. The interface 61 is attached to the wall surface along the reference line.

Next, a form (type) of the display tiles to be mounted is selected. For example, the base form shown in FIG. 7 (A) is selected (step S14). Display tiles are taken out of a storage cassette that stores many display tiles not shown (step S16).

As shown in FIG. 11 (C), a vertical marker and a horizontal marker (laser beam) indicating a position for attaching the display tile with the reference point Ps as a left upper corner are irradiated, and the display tile T is moved to this position and aligned (step S18). Next, the display tile T is connected to the interface 61, and fixed to the wall surface by an adhesive or an adhesive tape (step S20).

It is noted that, if necessary, correction may be performed to adjust the position, the hue, the luminance and the like of the display tile. The correction will be described below (step S22).

Thereafter, a similar process (steps S12 through S22) is repeated, whereby the display tiles are sequentially assembled from the left upper corner to the right lower corner while matching them with positioning markers to form a large-size screen. Finally, an end terminal section 71 is mounted at the connection section on the right end of a non-display tile array, and an end terminal resistance is connected to the signal bus 24 at each of the rows.

FIG. 12 is an explanatory view for describing the correction among mutual display tiles T. Each of the display tiles T is adjusted at the time of shipping out of factory to have a reference state or a designed state, and may not normally require any correction. However, it is natural to think that characteristic variations of the pixel elements actually have deviations in each of the display tiles. For example, in the case of a color display device, it is presumed that deviations from the specified color temperatures, in other words, deviations in hues and luminance in each of the three primary colors, may cause color irregularities among the display tiles. Also, when low-temperature polysilicon (LTPS) thin film transistors (TFT) are used for forming the driver circuits, such deviations may cause variations in the characteristics not only of the pixel elements but also of the pixel element driver circuits. Therefore, it is desirable that the hue, the luminance, the mounting position and the like are to be finely adjusted for each of the display tiles when the display tiles are installed on site. For adjustment of the parameters of the display tiles T, the correction method described in the aforementioned Japanese Laid-open Patent Application 2006-47901 may be used.

For example, an image sensor 62 formed with a CCD sensor or the like is placed at the border between display tiles T1 and T2, and a test pattern is sent from a correction device 63 to the display tiles T1 and T2 through the interface section 61 to have the display tiles display it. The test pattern displayed on the display tiles T1 and T2 is read by the image sensor 62, and a deviation is judged by the correction device, whereby the position of the display tile T2 is adjusted. Before hardening adhesive, fine adjustment can be made. Also, a test pattern with the same color signal and luminance signal is sent to the display tiles T1 and T2, and the test pattern displayed on the display tiles T1 and T2 is read by the image sensor 62. Deviations are judged by the correction device, and the display tile T2 or T1 is adjusted if any deviation is present. Error signals for the adjustment amounts are stored in the ROM 102 of the element processor described above. By this, deviations in display among the display tiles can be prevented. If any of the display tiles T exceed a standard error range, they are replaced with other display tiles T. For a display device that has been installed and used for a predetermined period of time, the correction device 63 may be used to make corrections for environmental changes (temperature, brightness and the like) and changes with time in display characteristics of the display tiles, whereby the display tiles may be replaced.

### Third Embodiment

FIG. 13 and FIG. 14 show a third embodiment. In these figures, portions corresponding to those in FIG. 9 are appended with the same reference numbers, and description of such portions shall be omitted.

In this embodiment, as shown in FIG. 13, an electro-optical device 1 is installed on a structure, such as, a column in a cylindrical shape. The electro-optical device 1 is formed by combining flexible sheet-like display tiles T or curved display tiles T into a cylindrical shape surrounding the exterior wall of the structure. In this embodiment, in order to form a display surface without boundaries to display an image thereon, the interface section 61 and the end terminal device 71 described above are not provided as independent units (see FIG. 8), but similar functions are built in the display tiles T.

FIG. 14 is for describing a specified one of the columns (in the vertical direction) among the plurality of display tiles T assembled into a cylindrical shape, wherein the display tiles T in this column (the center column) are provided with the second connection sections 52 (see FIG. 4) and the end terminal sections 54 described above. The connection sections 52 are provided at the rear surfaces of the display tiles T for transmitting image data signals from the main processor (host computer) to the signal buses 24. The signal buses 24 are electrically connected to the signal buses 24 of the adjoining display tiles T (on the right side) through the female and male connection sections 25 and 26. Such connections are repeated, thereby forming the signal bus that generally encircles all around the display tiles T that are assembled in a cylindrical shape.

The end terminal sections 54 are formed from a group of end terminal resistances, which are electrically connected to the female connection sections 26 of the display tiles T. The female connection sections 26 are electrically connected to the signal buses 24 (corresponding to the signal bus that generally encircles all around) of the adjoining display tiles T (on the left side) through the male connection sections 25. Image data signals are transmitted all around the signal bus to the end terminal sections 54, and their energy is absorbed by the end terminal sections 54, whereby signal reflection is prevented.

In this manner, by building the functions of the input interface 61 and the end terminal device 71 in the display tiles, it is possible to form an electro-optical device 1 with a display surface without boundaries or so-called frames.

It is noted that the display tiles T are installed on the external wall of the structure in the embodiments, but it is obvious from the embodiments that they can also be applied to an inner wall of a hollow structure (in a cylindrical shape). Also, the structure is not limited to buildings, columns or the like, but may be a foundation structure 20 that is fabricated as a mechanical structural frame.

Also, the internal structure of the display tile is not limited to the embodiments. As long as an image is formed in a corresponding region from image data signals, an electro-optical device with a large-size screen can be formed by combining display tiles.

Also, in the present embodiment, the display tile T may be a flexible sheet-like structure using a pixel element array composed of liquid crystal elements, organic EL elements, electrophoretic elements or the like formed on a film. By using such display tiles T, even when a wall surface has a curve, it is possible to form an electro-optical display device with a large-size screen along the curve. In this case, the display tiles T can be bonded to the wall surface with adhesive. Also, the display tiles T may be provided with protrusions protruding from one sides thereof and connectors formed thereon, whereby the adjoining display tiles T are overlapped with one another and electrically connected together through anisotropic conductive films.

Also, in each of the embodiments, various kinds of display tiles shown in FIG. 7 may be used.

1. An electro-optical device comprising: a plurality of display tiles and a foundation structure having a plurality of regions, wherein
the foundation structure is equipped with a signal bus for transmitting an image data signal to a first display tile among the plurality of display tiles, and a first connection section that electrically connects the signal bus with the first display tile, and
the first display tile is equipped with pixel elements, a signal processing section that generates signals for driving the pixel elements based on the image data signal, and a second connection section that is electrically connected to the first connection section.

2. An electro-optical device recited in claim 1, wherein the foundation structure includes a first mounting section for fixing the first display tile to a first region among the plurality of regions, and the first display tile includes a second mounting section to be attached to the first mounting section.

3. An electro-optical device that forms a large-size screen by combining a plurality of display tiles each of which displays a small-size screen, wherein each of the display tiles is equipped with
a signal bus for transmitting an image data signal,
a connection section that electrically connects the signal buses with one another on adjoining ones of the display tiles,
a plurality of pixel elements that form the small-size screen, and
a signal processing section that forms a signal for driving each of the pixel elements from the image data signal.

4. An electro-optical device recited in claim 3, wherein the large-size screen is formed by two-dimensionally arranging the plurality of display tiles and connecting the connection sections of adjoining ones of the display tiles with one another, and
further comprising an interface section that is provided at least at one end section of the large-size screen composed of the plurality of display tiles and relays an externally supplied image data signal to the signal bus of each of the plurality of display tiles disposed at the one end section.

5. An electro-optical device recited in claim 1, wherein the plurality of display tiles includes those in different configurations and different numbers of pixel elements.

6. An electro-optical device recited in claim 1, wherein the signal processing section of the display tile performs signal processing according to a hierarchical structure, and includes an uppermost layer that serves as an input interface for the image data, a lowermost layer in which the plurality of pixel elements and a plurality of pixel element driving circuits each corresponding to each of the pixel elements are arranged, and a middle layer that processes and computes data supplied from an upper layer and supplies the same to a lower layer.

7. An electro-optical device recited in claim 6, wherein the display tile further includes a non-volatile memory device that stores errors with respect to a target color and/or a target luminance caused by variations in each of the pixel elements and changes with time, and is equipped with a device that calculates an input value for the pixel element in the lowermost layer in a manner to cancel out the errors stored in the non-volatile memory.
